(19) United States
(12) Patent Application Publication
(10) Pub. No.: US 2011/0008105 A1
(43) Pub. Date: Jan. 13, 2011

(54) PROTECTIVE IRRIGATION APPARATUSES, SYSTEMS, AND METHODS

(76) Inventor: Kevin B. Soergel, Gibsonia, PA (US)

Correspondence Address: THE LAW OFFICE OF RICHARD W. JAMES, 25 CHURCHILL ROAD, CHURCHILL, PA, 15235, US

(21) Appl. No.: 12/501,737

(22) Filed: Jul. 13, 2009

(51) Int. Cl. E02B 13/00; B23P 17/04

(52) U.S. Cl. 405/43; 29/428; 405/36

(57) ABSTRACT

Methods, systems, and apparatuses for protective irrigation. A protective irrigation apparatus includes a substrate having a plurality of perpendicular weight supporting members extending therefrom and an irrigation line attached adjacent to the substrate between the perpendicular weight supporting members.

### FIELD OF THE INVENTION

This invention is related to irrigation that is efficient, protected from damage, and simple to install. The invention is more particularly directed to methods, systems, and apparatuses for simplifying installation of irrigation, for protecting irrigation components, and for efficient irrigation.

### BACKGROUND OF THE INVENTION

Traditional residential and commercial irrigation systems are inefficient, wasteful, and easily damaged. For example, much of the water dispensed by pop-up irrigation systems evaporates or runs off and never reaches the plants it is intended to water. Further, the wastefulness of pop-up irrigation system has lead to municipal, regional, and state restrictions on their use.

Drip irrigation lines, whether disposed on the surface of the ground or underground, are easily damaged by pedestrian or vehicle traffic passing over the drip lines. Moreover, current irrigation systems are time consuming to install and frequently installed incorrectly.

Accordingly, there is a need for irrigation apparatuses, systems, and methods that use water efficiently.

There is also a need for irrigation apparatuses, systems, and methods that are resistant to damage from pedestrians and light vehicles.

There is a further need for irrigation apparatuses, systems, and methods that simplify irrigation installation and a need for irrigation apparatuses, systems, and methods that improve irrigation installation.

### SUMMARY OF THE INVENTION

The present invention is directed to protective irrigation systems, methods and apparatuses. In accordance with one form of the present invention, there is provided an irrigation apparatus having a substrate with a plurality of perpendicular weight supporting members extending therefrom. An irrigation line is attached adjacent to the substrate between the perpendicular weight supporting members. It should be recognized that more than one irrigation line may be used if desired. The irrigation apparatus may include a coupling on the irrigation line for coupling to another irrigation line, another section of irrigation apparatus, or a water source. Alternately, a manifold may be coupled to a water source and provide water from the water source to a plurality of irrigation apparatus sections.

A method of forming an irrigation apparatus is also provided. The method includes attaching irrigation tubing to a substrate between perpendicular weight supporting members extending from the substrate. In one embodiment, the formed irrigation apparatus is rolled and bound for transport to a remote site desired to be irrigated.

A method of installing an irrigation system is also provided. That method includes unrolling a first irrigation apparatus having a substrate having a plurality of perpendicular weight supporting members extending therefrom and at least one irrigation line attached adjacent to the substrate between the perpendicular weight supporting members, connecting the irrigation line to a water source, and covering the first irrigation apparatus with earth. In that method, one or more additional irrigation apparatuses may be unrolled adjacent the first irrigation apparatus. The first and second irrigation apparatuses may be coupled together and also coupled to a water source. Alternately, a manifold may be coupled to a water source and provide water from the water source to the first and second irrigation apparatuses.

Accordingly, the present invention provides solutions to the shortcomings of prior irrigation systems, apparatuses, and methods. Those of ordinary skill in irrigation will readily appreciate, therefore, that those details described above and other details, features, and advantages of the present invention will become further apparent in the following detailed description of the preferred embodiments of the invention.

### BRIEF DESCRIPTION OF THE DRAWINGS

The accompanying drawings, wherein like reference numerals are employed to designate like components, are included to provide a further understanding of protective irrigation apparatuses, systems, and methods, are incorporated in and constitute a part of this specification, and illustrate embodiments of protective irrigation apparatuses, systems, and methods that together with the description serve to explain the principles of protective irrigation apparatuses, systems and methods.

Various other objects, features and advantages of the invention will be readily apparent according to the following description exemplified by the drawings, which are shown by way of example only, wherein:

FIG. 1 illustrates a perspective view of an embodiment of a protective irrigation apparatus;

FIG. 2 illustrates a top view of four interconnected sections of the protective irrigation apparatus of FIG. 1; and

FIG. 3 illustrates a side view of the multi-section protective irrigation apparatus of FIG. 2 with a manifold for connecting the sections of protective irrigation apparatus to a water source.

### DETAILED DESCRIPTION

Reference will now be made to embodiments of protective irrigation apparatuses, systems, and methods, examples of which are illustrated in the accompanying drawings. Details, features, and advantages of the protective irrigation apparatuses, systems, and methods will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

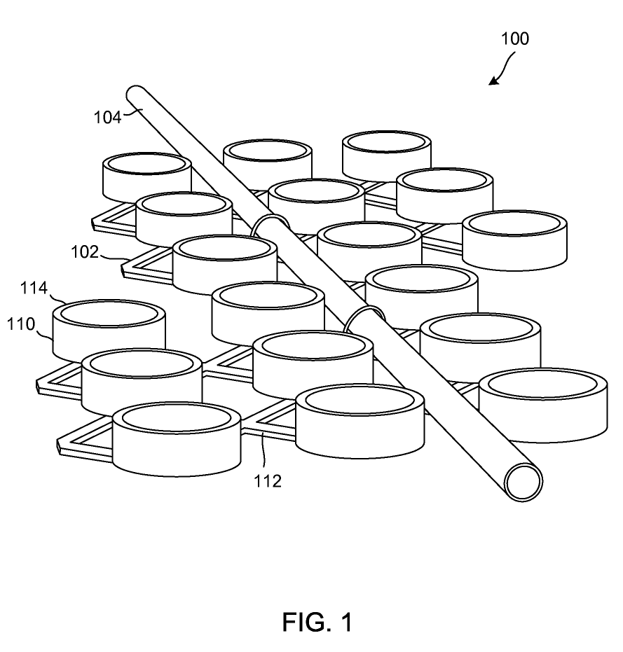

FIG. 1 illustrates a protective irrigation apparatus 100 having a substrate 102 and at least one irrigation line 104 attached to the substrate 102. The substrate 102 may include, for example, turf reinforcement products 110.

Turf reinforcement products 110 may form a grid 112 with perpendicular weight supporting members 114 upon which earth may be placed and plants may be grown. Weight, such as that of a person or a vehicle, may be applied to the perpendicular weight supporting members 114, either directly or through earth placed on top of the turf reinforcement product 110, and that weight may be distributed to the grid 112 by the perpendicular weight supporting members 114 to prevent or minimize the creation of depressions in the earth where the weight is applied. Thus, for example, a lawn may be grown over a turf reinforcement product such that light vehicular and pedestrian traffic may be placed on the lawn without creating ditches or downtrodden paths in the lawn.

It should be noted that the term “earth” as used herein, may include any solid matter or any planting medium, including, for example, stone, gravel, sand, soil, topsoil, compost, fertilizer, and water holding polymers, or any combination of such materials.

Other substrates, including soil retention mats, erosion control grids, geotextile grids, slope reinforcement grids or fabrics, gravel or soil stabilization grids, green roof membranes, or other substrates may alternately be used in place of the turf reinforcement product 110 and the irrigation line or lines 104 may be attached thereto.

The irrigation line or lines 104 may be any available drip irrigation tubing, rigid or flexible tubing made of metal, plastic, rubber, or any material or combination of materials desired. The irrigation line or lines 104 may be attached to the perpendicular weight supporting members 114 such that it is continuous, having one inlet and one outlet or may be capped at its ends or tapped at a mid-point of the irrigation line or lines 104 as desired.

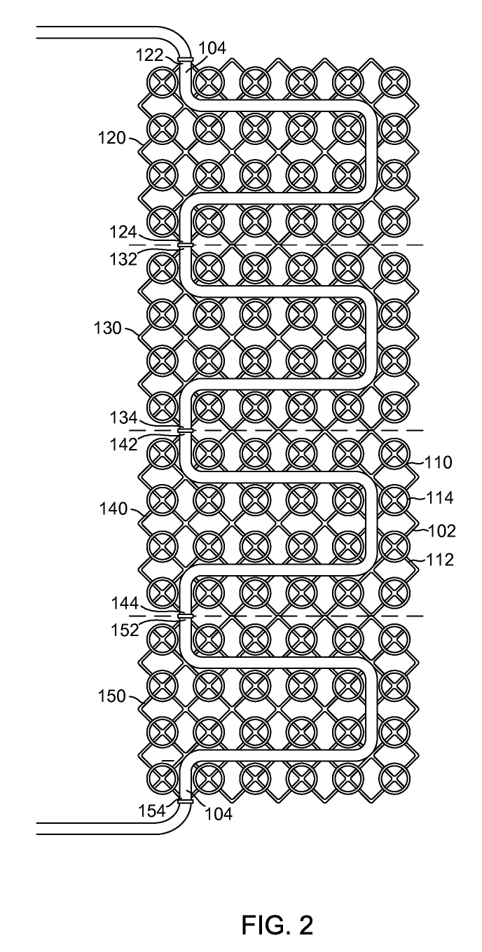

For example, in one embodiment, the irrigation line or lines 104 are flexible plastic tubing that is attached along the length of the protective irrigation apparatus 100 between rows of perpendicular weight supporting members 114, wrapped around a perpendicular weight supporting members 114 at or near one end of the protective irrigation apparatus 100 and then attached back along the length of the protective irrigation apparatus 100 between adjacent perpendicular weight supporting members 114, as illustrated in FIG. 2. That process may be repeated until the irrigation line or lines 104 is run through a desired portion or the entire protective irrigation apparatus 100. It should be noted that the pipe need not be run between every adjacent row of perpendicular weight supporting members 114, but may rather be attached at any desired interval between adjacent perpendicular weight supporting members 114 or otherwise as desired.

In another embodiment, rigid pipe irrigation line or lines 104 are run at intervals, such as between adjacent rows of perpendicular weight supporting members 114 or every second or third row of perpendicular weight supporting members 114, along the length of the protective irrigation apparatus 100. Fittings are then attached to connect adjacent ends of the rigid pipe irrigation line or lines 104 to create a continuous pipeline through the protective irrigation apparatus 100 with openings at two ends.

The protective irrigation apparatus 100 may be installed on level ground, sloping ground, roof gardens, or elsewhere, as desired.

A method of forming a protective irrigation apparatus 100 includes attaching irrigation tubing 104 to a substrate 102 between perpendicular weight supporting members 114 extending from the substrate 102. The irrigation tubing 104 may be drip irrigation tubing and it may be attached to the substrate 102 by clamps, tie-wraps, zip-ties, straps, clamps, biodegradable ties such as rope or string, banding, or as desired. Once created, sections of protective irrigation apparatus 100 may be rolled or stacked in sections. When rolled, the sections of protective irrigation apparatus 100 may be bound with biodegradable material, strapped with nylon, polypropylene, or polyester strapping, or otherwise bound as desired.

A method of installing a protective irrigation apparatus 100 includes unrolling or otherwise laying out one or more sections of protective irrigation apparatus 100, connecting the protective irrigation apparatus 100 to a water source and covering the protective irrigation apparatus 100 with earth. In applications where two or more sections of protective irrigation apparatus 100 are installed in a location, the irrigation tubing of the sections of protective irrigation apparatus 100 may be connected to one another or may each be separately connected to a water source.

When rolled sections of protective irrigation apparatus 100 are bound with biodegradable material, one or more rolls of protective irrigation apparatus 100 may be set in place, the bindings may be cut or otherwise unfastened, and the protective irrigation apparatus 100 may be unrolled in place, leaving the biodegradable binding material in place with the protective irrigation apparatus.

The protective irrigation apparatus 100 may be installed as panel sections, for example one or more 4′×8′ stackable flat or flexible panel sections, or one or more 8′×100′ rolled sections. For example, in an embodiment, one or more 4′ wide by 12′ long rolls of protective irrigation apparatus 100 are placed side by side and/or end to end to cover the area desired to be irrigated and to form the protective irrigation apparatus 100. Where multiple sections of protective irrigation apparatus 100 are used in an installation, after the sections have been laid out, the irrigation lines 104 may be connected to one another and to a water source.

FIG. 2 illustrates an embodiment where four sections 120, 130, 140, and 150 of protective irrigation apparatus 100, each having a single length of irrigation line 104, are used in a single protective irrigation apparatus 100 installation. A first end 122 of the irrigation line 104 in a first section 120 of protective irrigation apparatus 100 may be connected to a water source. A second end 124 of the first section 120 of the protective irrigation apparatus 100 may be connected to the first end 132 of the irrigation line 104 in a second section 130 of protective irrigation apparatus 100 used in the installation. Similarly, a second end 134 of the second section 130 of the protective irrigation apparatus 100 may be connected to the first end 142 of the irrigation line 104 in a third section 140 of protective irrigation apparatus 100 used in the installation. A second end 144 of the third section 140 of the protective irrigation apparatus 100 may be connected to the first end 152 of the irrigation line 104 in a fourth section 150 of protective irrigation apparatus 100 used in the installation. A second end 154 of the irrigation line 104 in the fourth section 150 of the protective irrigation apparatus 100 used in the installation may then be connected to the water source such that both ends of the four section protective irrigation apparatus 100 are connected to the water source.

Alternately, the second end 154 of the irrigation line 104 of the last section 150 of the protective irrigation apparatus 100 may be capped. Where the second end 154 of the irrigation line 104 of the last section 150 of the protective irrigation apparatus 100 is capped, that second end 154 of the irrigation line 104 may be capped, for example, using a pipe cap in a rigid pipe installation or by doubling a flexible pipe back on itself and fastening the doubled pipe using a clamp or wire tie, for example. As will be recognized, any other desired capping method may be used including, for example any method commonly used in irrigation systems.

Alternately, the second end 154 of the irrigation line 104 in the last section 150 of an installation may be connected to one or more pipes running to another area where water is desired or anywhere else desired.

To provide good water flow and pressure throughout the system, one or more water sources may be connected at the second end 154 of the irrigation line 104 in the last section 150 of protective irrigation apparatus 100 in the installation as well as to the first end 122 of the first section 120 of protective irrigation apparatus 100 in the installation.

In yet another embodiment, the water source is connected at other than an end of an irrigation line 104, for example, the middle of the irrigation line 104 as it runs through a single-section or multi-section protective irrigation apparatus 100. In such an embodiment, both ends of the irrigation line 104 may be capped, thereby providing more evenly distributed pressure throughout the irrigation line 104 and the protective irrigation apparatus 100 with a single water source connection point.

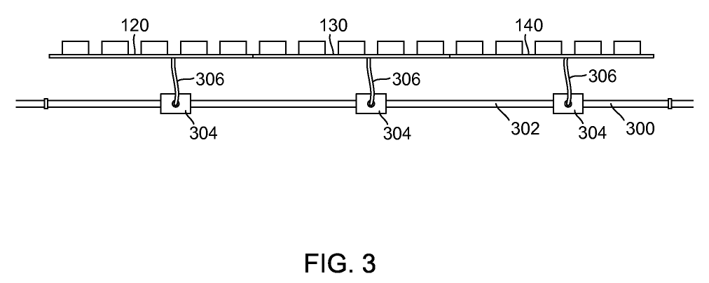

FIG. 3 illustrates a side view of an embodiment of a multi-section protective irrigation apparatus 100 using a manifold 300 to provide water to the plurality of protective irrigation apparatus 100 sections 120,130, and 140. In such an embodiment, a rigid or flexible pipe or tube 302 is run above or below ground. The pipe or tube 302 includes a plurality of ports 304 for connection to the plurality of sections 120, 130, and 140 of protective irrigation apparatus 100. Rigid or flexible pipe or tubing 306 is then used to connect the ports 304 of the manifold 300 to the protective irrigation apparatus 100 sections 120, 130, and 140. For example, a first port 304 on the manifold 300 may be used to connect to the first section 120 of the protective irrigation apparatus 100. Other manifold 300 ports 304 may then be used to connect to one or more additional protective irrigation apparatus 100 sections 120, 130, and 140. Unused ports 304 may be capped or otherwise closed. The manifold is then connected, at one or both ends, to a water source to provide water to the protective irrigation apparatus 100 sections 120, 130, and 140.

In another embodiment, a protective irrigation apparatus 100 may be used in conjunction with a pop-up sprinkler system, such as an existing pop-up sprinkler system. In such an embodiment, a pop-up head may be removed from the pop-up sprinkler system and a pipe or tube may be connected from the place where the pop-up sprinkler head was removed to the protective irrigation apparatus 100 for use as a water source.

The water source may include any water source desired, including a public water source, a well, a rain barrel, or a recirculating rain water collection system.

In one embodiment, the protective irrigation apparatus 100 is installed by placing one or more protective irrigation apparatus 100 sections on an earthen surface, such as an existing lawn, flowerbed, ground cover bed, garden, turf or grass. Sections are then attached to one another and the water source. The protective irrigation apparatus 100 may then be compacted into the earthen surface. In one embodiment, the earthen surface is wetted before compacting to aid in the compaction process.

While specific embodiments of the invention have been described in detail, it should be appreciated by those skilled in the art that various modifications and alternations could be developed in light of the overall teachings of the disclosure. Accordingly, the particular arrangements, apparatuses, systems, and methods disclosed are meant to be illustrative only and not limiting as to the scope of the invention.

What is claimed is:

1. An irrigation apparatus, comprising:
a substrate having a plurality of perpendicular weight supporting members extending therefrom; and
an irrigation line attached adjacent to the substrate between the perpendicular weight supporting members.

2. The irrigation apparatus of claim 1, wherein the weight supporting members are spaced at intervals.

3. The irrigation apparatus of claim 1, wherein the irrigation apparatus is to be covered with earth.

4. The irrigation apparatus of claim 3, wherein lawn is to be placed on the earth covering the irrigation apparatus.

5. The irrigation apparatus of claim 3, wherein shrubbery is to be placed in the earth covering the irrigation apparatus.

6. The irrigation apparatus of claim 3, wherein at least one of a vegetable garden, a flower garden, ground cover, and a roof garden cooling system is to be placed in the earth covering the irrigation apparatus.

7. The irrigation apparatus of claim 1, wherein the irrigation line is a pipe having a first surface in contact with the substrate and a second surface opposite the substrate at an irrigation line furthest distance from the substrate, and wherein the weight supporting members extend from the substrate to the irrigation line furthest distance from the substrate.

8. The irrigation apparatus of claim 1, wherein the irrigation line is a drip irrigation line.

9. The irrigation apparatus of claim 1, wherein the substrate is flexible enough to be rolled into a roll.

10. The irrigation apparatus of claim 9, wherein the roll is bound.

11. The irrigation apparatus of claim 1, further comprising a coupling attached to the irrigation line.

12. A method of forming an irrigation apparatus, comprising attaching irrigation tubing to a substrate between perpendicular weight supporting members extending from the substrate.

13. The irrigation method of claim 12, wherein the irrigation apparatus and irrigation tubing are both flexible.

14. The irrigation method of claim 13, further comprising rolling the irrigation apparatus.

15. The irrigation method of claim 14, further comprising binding the rolled irrigation apparatus.

16. The irrigation method of claim 15, wherein the binding is biodegradable.

17. The irrigation method of claim 12, wherein the irrigation tubing is attached to the irrigation apparatus by at least one of a zip-tie, hook, strap, and clamp.

18. An irrigation method, comprising:
unrolling a first irrigation apparatus having a substrate having a plurality of perpendicular weight supporting members extending therefrom and an irrigation line attached adjacent to the substrate between the perpendicular weight supporting members;
connecting the irrigation line to a water source; and
covering the first irrigation apparatus with earth.

19. The irrigation method of claim 18, further comprising:
unrolling a second irrigation apparatus having a substrate having a plurality of perpendicular weight supporting members extending therefrom and an irrigation line attached adjacent to the substrate between the perpendicular weight supporting members;
coupling the irrigation line of the first irrigation apparatus to the irrigation line of the second irrigation apparatus; and
covering the second irrigation apparatus with earth.

20. The irrigation method of claim 18, further comprising unbinding the protective irrigation apparatus and leaving the binding in place with the protective irrigation apparatus.
